(19) United States
(12) Patent Application Publication
(10) Pub. No.: US 2008/0316430 A1
(43) Pub. Date: Dec. 25, 2008

(54) PROJECTION APPARATUS

(75) Inventors: Chun-Fa Hsu, Hsinchu (TW); Chao-Shun Chen, Hsinchu (TW); Hung-Cheng Lung, Hsinchu (TW); S-Wei Chen, Hsinchu (TW); Mei-Ling Chen, Hsinchu (TW); Cheng-Shun Liao, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 11/873,258

(22) Filed: Oct. 16, 2007

(30) Foreign Application Priority Data
Jun. 20, 2007 (TW) 96122015

(51) Int. Cl. G03B 21/28

(52) U.S. Cl. 353/20

(57) ABSTRACT

A projection apparatus including an illumination system, a reflective light valve and an imaging system is provided. The illumination system emits an illumination beam. The reflective light valve is disposed on a transmission path of the illumination beam. The imaging system includes a first lens group, a polarization beam splitter and a second lens group. The first lens group is disposed on the transmission path of the illumination beam between the illumination system and the reflective light valve. The polarization beam splitter is disposed on the transmission path of the illumination beam between the illumination system and the first lens group. The polarization beam splitter permits the illumination beam to pass through and travel to the reflective light valve. The reflective light valve modulates the illumination beam to an image beam traveling to the polarization beam splitter. The polarization beam splitter reflects the image beam to the second lens group.

### CROSS-REFERENCE TO RELATED APPLICATION

This application claims the priority benefit of Taiwan application serial no. 96122015, filed Jun. 20, 2007. All disclosure of the Taiwan application is incorporated herein by reference.

### BACKGROUND OF THE INVENTION

1. Field of the Invention

The present invention relates to a display apparatus, and more particularly to a projection apparatus.

2. Description of Related Art

Referring to FIG. 1, a conventional projection apparatus 100 includes an illumination system 110, a polarization beam splitter 120, a liquid crystal on silicon panel (LCOS panel) 130, and an imaging system 140. The illumination system 110 is capable of emitting an illumination beam 112 to the polarization beam splitter 120. The polarization beam splitter 120 is capable of reflecting the illumination beam 112 with an S polarization direction to the LCOS panel 130. The LCOS panel 130 is capable of modulating the illumination beam 112 with the S polarization direction to an image beam 132 with a P polarization direction and reflecting the image beam 132 to the polarization beam splitter 120. The polarization beam splitter 120 is capable of permitting the image beam 132 with the P polarization direction to pass through and travel to the imaging system 140.

The imaging system 140 includes a first lens group 142, a second lens group 144 and a reflecting mirror 146. The image beam 132 with the P polarization direction passing through the polarization beam splitter 120 passes through the first lens group 142, and is reflected to the second lens group 144 by the reflecting mirror 146, and the second lens group 144 is capable of projecting the image beam 132 onto a screen (not shown), so as to generate an display image on the screen.

Currently, electronic devices are designed in the trend of small volume. However, in the conventional projection apparatus 100, the illumination system 110 and the imaging system 140 are independent systems, so large space must be occupied, such that the volume of the entire projection apparatus 100 is hard to be reduced.

### SUMMARY OF THE INVENTION

The present invention is directed to a projection apparatus, which has a simplified structure and reduced number of optical elements, which help to reduce the overall volume of the projection apparatus.

An embodiment of the present invention provides a projection apparatus including an illumination system, a reflective light valve and an imaging system. The illumination system is capable of emitting an illumination beam. The reflective light valve is disposed on a transmission path of the illumination beam. The imaging system includes a first lens group, a polarization beam splitter and a second lens group. The first lens group is disposed on the transmission path of the illumination beam and between the illumination system and the reflective light valve. The polarization beam splitter is disposed on the transmission path of the illumination beam and between the illumination system and the first lens group. The polarization beam splitter is capable of permitting the illumination beam with a first polarization direction to pass through and permitting the illumination beam with the first polarization direction to travel to the reflective light valve. The reflective light valve is capable of modulating the illumination beam with the first polarization direction to an image beam with a second polarization direction and reflecting the image beam to the polarization beam splitter. The polarization beam splitter is capable of reflecting the image beam to the second lens group.

Accordingly, the polarization beam splitter is integrated in the imaging system, and the first lens group has the function of condensing the illumination beam to the reflective light valve in addition to an imaging function, thereby reducing the number of the light condensing elements in the illumination system. Therefore, the projection apparatus has a simplified structure, thereby helping to reduce the overall volume of the projection apparatus.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural view of a conventional projection apparatus.

FIG. 2 is a schematic structural view of a projection apparatus according to an embodiment of the present invention.

FIG. 3 is a schematic structural view of a projection apparatus according to another embodiment of the present invention.

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

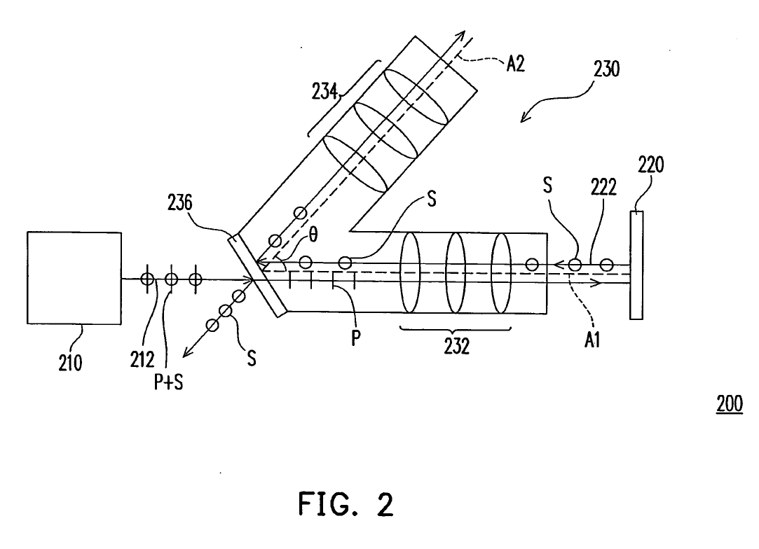

Referring to FIG. 2, a projection apparatus 200 according to an embodiment of the present invention includes an illumination system 210, a reflective light valve 220, and an imaging system 230. The illumination system 210 is capable of emitting an illumination beam 212, and the illumination beam 212 includes beams with a first and a second polarization directions. The reflective light valve 220 is disposed on the transmission path of the illumination beam 212. The imaging system 230 includes a first lens group 232, a second lens group 234 and a polarization beam splitter 236. The first lens group 232 is disposed on the transmission path of the illumination beam 212 and between the illumination system 210 and the reflective light valve 220. The polarization beam splitter 236 is disposed on the transmission path of the illumination beam 212 and between the illumination system 210 and the first lens group 232. The polarization beam splitter 236 is capable of permitting the illumination beam 212 with the first polarization direction to pass through and permitting the illumination beam 212 with the first polarization direction to travel to the reflective light valve 220. The polarization beam splitter 236 is also capable of reflecting the illumination beam 212 with the second polarization direction. The reflective light valve 220 is capable of modulating the illumination beam 212 with the first polarization direction to an image beam 222 with the second polarization direction and reflecting the image beam 222 to the polarization beam splitter 236. The polarization beam splitter 236 is capable of reflecting the image beam 222 to the second lens group 234, and the second lens group 234 is capable of projecting the image beam 222 onto a screen (not shown), so as to generate an display image on the screen. In this embodiment, each of the first lens group 232 and the second lens group 234 includes at least one optical lens.

In this embodiment, the first polarization direction is substantially perpendicular to the second polarization direction. The first polarization direction is, for example, a P polarization direction, and the second polarization direction is, for example, an S polarization direction (as shown in FIG. 2). However, in other embodiments, the first polarization direction and the second polarization direction are also the S polarization direction and the P polarization direction, respectively.

In this embodiment, the reflective light valve 220 is a liquid crystal on silicon panel (LCOS panel). Moreover, the illumination beam 212 incident on the reflective light valve 220 and the image beam 222 reflected by the reflective light valve 220 are substantially perpendicular to the reflective light valve 220. In addition, in this embodiment, an angle θ formed between the optical axis A1 of the first lens group 232 and the optical axis A2 of the second lens group 234 is smaller than 90 degrees. However, in other embodiments, the angle θ is equal to or greater than 90 degrees by adjusting the disposition angles of the polarization beam splitter 236 and the second lens group 234.

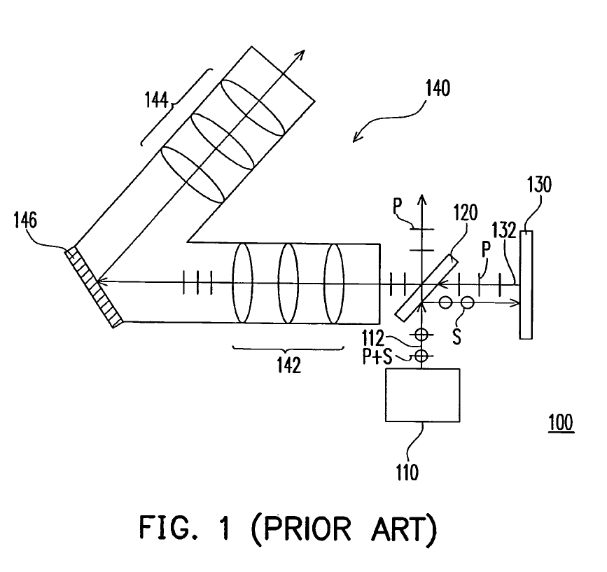

In this embodiment, the polarization beam splitter 236 is integrated in the imaging system 230, so as to replace the reflecting mirror 146 (as shown in FIG. 1) in the prior art. Compared with the conventional projection apparatus 100, one reflecting mirror 146 is reduced in the projection apparatus 200 of this embodiment, and thus the cost of the projection apparatus 200 is reduced. Moreover, the space occupied by the conventional polarization beam splitter 120 is also saved, thereby helping to reduce the overall volume of the projection apparatus 200.

Moreover, both the illumination beam 212 and the image beam 222 pass through the first lens group 232, so the first lens group 232 has the function of condensing the illumination beam 212 to the reflective light valve 220 in addition to an imaging function, thereby reducing the number of light condensing elements applied in the illumination system 210. Therefore, the projection apparatus 200 of this embodiment has a simplified structure, thereby helping to reduce the overall volume of the projection apparatus 200 and reduce the cost of the projection apparatus 200.

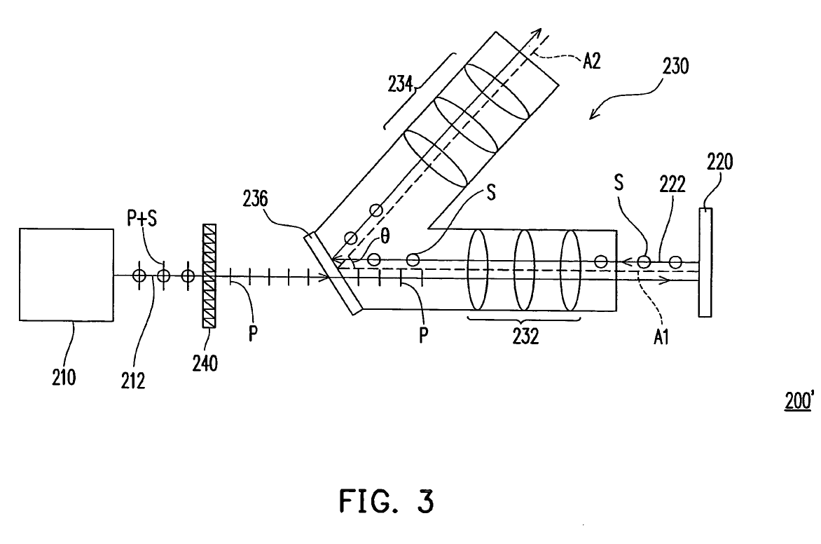

FIG. 3 is a schematic structural view of a projection apparatus according to another embodiment of the present invention. Compared with the projection apparatus 200 (as shown in FIG. 2) of the above embodiment, the projection apparatus 200′ of this embodiment has an additional polarization conversion system 240 disposed on the transmission path of the illumination beam 212 and between the illumination system 210 and the polarization beam splitter 236. The polarization conversion system 240 is capable of converting the illumination beam 212 with any polarization direction into the same polarization direction, e.g., the first polarization direction. Accordingly, more proportion of illumination beam 212 passes through the polarization beam splitter 236, thereby improving the brightness of the display image projected by the projection apparatus 200′.

In view of the above, compared with the prior art, the present invention integrates the polarization beam splitter into the imaging system without using the reflecting mirror, so the cost and the volume of the projection apparatus is reduced. Moreover, in the present invention, both the illumination beam and the image beam pass through the first lens group, and thus the first lens group has the function of condensing the illumination beam to the reflective light valve in addition to the imaging function, thereby reducing the number of the light condensing elements in the illumination system. Therefore, the projection apparatus of the present invention has a simplified structure, which helps to reduce the overall volume of the projection apparatus.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
an illumination system, capable of emitting an illumination beam;
a reflective light valve, disposed on a transmission path of the illumination beam;
an imaging system, comprising:
a first lens group, disposed on the transmission path of the illumination beam and between the illumination system and the reflective light valve;
a polarization beam splitter, disposed on the transmission path of the illumination beam and between the illumination system and the first lens group, wherein the polarization beam splitter is capable of permitting the illumination beam with a first polarization direction to pass through and permitting the illumination beam with the first polarization direction to travel to the reflective light valve, and the reflective light valve is capable of modulating the illumination beam with the first polarization direction to an image beam with a second polarization direction and reflecting the image beam to the polarization beam splitter; and
a second lens group, wherein the polarization beam splitter is capable of reflecting the image beam to the second lens group.

2. The projection apparatus as claimed in claim 1, wherein the reflective light valve is a liquid crystal on silicon panel.

3. The projection apparatus as claimed in claim 1, wherein the illumination beam incident on the reflective light valve and the image beam reflected by the reflective light valve are substantially perpendicular to the reflective light valve.

4. The projection apparatus as claimed in claim 1, wherein the first polarization direction is substantially perpendicular to the second polarization direction.

5. The projection apparatus as claimed in claim 1, wherein each of the first lens group and the second lens group comprises an optical lens.

6. The projection apparatus as claimed in claim 1, wherein an angle formed between an optical axis of the first lens group and an optical axis of the second lens group is equal to 90 degrees.

7. The projection apparatus as claimed in claim 1, wherein an angle formed between an optical axis of the first lens group and an optical axis of the second lens group is smaller than 90 degrees.

8. The projection apparatus as claimed in claim 1, wherein an angle formed between an optical axis of the first lens group and an optical axis of the second lens group is greater than 90 degrees.

9. The projection apparatus as claimed in claim 1, further comprising a polarization conversion system disposed on the transmission path of the illumination beam and between the illumination system and the polarization beam splitter, wherein the polarization conversion system is capable of converting polarization directions of the illumination beam into the first polarization direction.
